(19) United States
(12) Patent Application Publication
(10) Pub. No.: US 2002/0120503 A1
(43) Pub. Date: Aug. 29, 2002

(54) Advertising method and advertising device

(75) Inventors: Noboru Iwayama, Kawasaki (JP); Madoka Mitsuoka, Kawasaki (JP); Youji Kohda, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, kawasaki (JP)

(21) Appl. No.: 09/892,732

(22) Filed: Jun. 28, 2001

(30) Foreign Application Priority Data
Jan. 29, 2001 (JP) 2001-019952

(51) Int. Cl. G06F 17/60

(52) U.S. Cl. 705/14

(57) ABSTRACT

Method and device for broadcasting over a network in a simple manner effective advertising likely to be taken in by users. Advertising registration process and advertising broadcast process are conducted. In advertising registration process an advertising server 1 accepts from an advertiser terminal 51 both the designation of an advertisement URL correlated with an advertisement and advertising information. This advertising information includes an advertisement icon and a hyperlink to an URL for details providing detailed advertising information. The advertising server 1 correlates advertising information it has received with the designated advertisement URL and stores this in an advertising DB 11. In advertising broadcast process, the following steps are conducted: (1) browse URL process, in which the URL for Web content being displayed at a user terminal 2b is sent to the advertising server 1; (2) advertising extract process, in which advertising corresponding to the browse URL is extracted from the advertising DB 11; and (3) advertising display process, in which an advertisement is sent from the advertising server 1 to a user terminal 2a, and the advertisement is displayed at the user terminal 2a.

### BACKGROUND OF THE INVENTION

1. Technical Field

The present invention relates to advertising techniques utilizing systems that via networks enable mutual consulting of status among users.

In the present invention, a status administration system is made up of a plurality of user terminals connected over a network. Via a network the system acquires information relating to the status of users, and per user correlatively stores the status information. A user terminal can request and acquire status information on a desired user. Preferred are those systems in which users one wishes to consult are registered in advance in order to acquire and display in a list status information on the pre-registered users when a connection to the system is made. Examples of status administration systems include destination display systems and attendance administration systems used in companies, and buddy list systems.

In the present invention, “resources” means data files e.g., MP3 files, text files, and binary files, and program files such as EXE files.

2. Description of Related Art

Services offered free of charge on the Internet are almost all made possible by advertising fees. Specifically, most free services are supported by the fees received for including banner ads as part of the content.

A typical advertising method on the Web displays ads in the following way. In the content of a Web page link information for advertising content is included, and the advertising content and the Web content are made to appear as one document by a Web browser. Usually, embedded in the displayed advertisement is a hyperlink to an advertising source that presents detailed information about the advertisement. Accordingly, a user mouse-clicks on the advertisement to consult detailed information at that advertising source (see Doubleclick Inc.'s U.S. Pat. No. 5,948,061).

Methods of determining the fee for displaying advertisements divide broadly into the following three ways: 1) a method that computes based on the number of times Web content is consulted; 2) a method that computes based on the number of times detailed information linked to an advertisement is consulted; and 3) a method that computes based on purchase amount and purchase frequency when detailed information is consulted, and that moreover leads to product purchase.

With the spread of the Internet, status administration systems such as buddy list systems are rapidly gaining in popularity. With buddy list systems, a user has a list for registering friends and colleagues as buddies. These types of lists are usually called buddy lists. When a user registers a buddy, whether his friends or colleagues are connected or not, and whether they are at their desk, are busy, or other such user status is correlated with the friend or colleague registered on the buddy list and displayed on the screen. A user can look up the status of a buddy, and activate a communication means from the buddy list appropriate to the buddy status. Examples of such communication means include, for example, instant messaging systems such as ICQ and AOL Instant Messenger, e-mail systems, and the telephone.

An advantage with Web advertising, typified by banner ads, is that because advertisement is annexed to Web content, a user in browsing the Web content inevitably browses the banner ads also.

However, a problem from the perspective of advertisers wishing to run banner ads is that it is doubtful whether users really pay attention to banner ads. Banner ads are annexed to Web content, but are small in display area compared to the content, and generally numerous banners are present on the same page. Therefore a banner ad itself is not likely to attract a user's attention. Furthermore, the current situation is that because simply by scrolling a user can remove a banner ad from the range of a Web browser's display, banner ads cannot be counted on to be highly effective advertising.

Banner ads have the following problems from the perspective of the Web content owner who permits banner ads. The Web content owner must perform editing to secure banner ad display areas beforehand in the content. The presence of ads therefore places restrictions on content layout, complicating the preparation of content.

From the perspective of a user browsing advertising over a network, another issue regarding Web advertising has been identified. The problem is that simply running ads on a network does not translate directly into the use of a service or the purchase of a product. A major factor in a user's making up his or her mind to purchase services or products is the opinion of family and friends, and advertising seems to do little more than bear the role of making the existence of a product known.

On the other hand, to give an example, apart from banner ads, of a network advertising method, so-called optin mail is an advertising method in which only genres of advertisements for which consent has been obtained from a consumer who is interested are broadcast by e-mail. However, in order to create the opportunity to have a user apply for opt-in mail, there is no choice but to rely on another means of advertising.

Among the instant messaging services such as ICQ and AOL Instant Messenger (IM services) services exist that display advertising display areas on users terminals. However, because IM services provide private communication between users, the presentation of ads that have nothing to do with users will not only have a marginal effect, but on the contrary may provoke backlash from users, and these services cannot very well be expected to be an effective advertising medium.

An object of the present invention is to provide a technique for expediently broadcasting on a network highly effective advertisements likely to be taken in by users.

### SUMMARY OF THE INVENTION

In order to resolve the aforementioned problems, a first aspect of the present invention presents an advertising method that broadcasts advertisements to a user-operated, network-interconnected computers, including a first computer operated by a first user and a second computer operated by a second user. This method includes the following steps:

a status administration step of administrating status of users including the first user and the second user;

a status broadcast step of receiving from the first computer and broadcasting to the second computer the status of the first user;

a memory step of correlatively recording in an advertising database resource identification information specifying a resource on the network with advertising information including image data for the advertisements;

an advertising acceptance step of accepting from the computers at least one selected from the resource identification information and the advertising information to be recorded by the memory step;

a storing step of storing in the advertising database information received in the advertising acceptance step;

a resource detection step of detecting resource identification information for a first resource in use by the first user;

an extraction step of extracting from the advertising information recorded in the memory step first advertising information corresponding to the resource identification information for the first resource, detected in the detection step;

a broadcast step of broadcasting to the second computer the first advertising information extracted in the extraction step; and

an advertising step of displaying as status of the first user on the second computer advertising image data included in the first advertising information broadcast in the broadcast step.

The above computers include portable terminals. Resources on the network are Web content, multimedia data such as MP3 files and MIDI files, applications used by computers interconnected over the network, and the like. Resource identification information can be the URL of a Web page, the file name of multimedia data, the execution file name of an application, and the like. Advertising image data included in advertising information can be an icon file displaying a corporate symbol of an advertiser or an identifier for specifying an icon file. In addition to icon files, advertising information may include the URL of a Web page on which more detailed advertising content is carried. Advertising content and resources stored in the advertising database (DB) may have no relation with each other, as with banner ads in Web content.

Suppose for example that on a buddy list system, user A looks up the status of user B. When user B uses a Web browser to consult Web content specified by “URL1,” resource identification information “URL1” is detected. Then, advertising correlated with “URL1” is displayed on user A's computer as the status of the second user.

User A, because the status of his acquaintance user B is displayed by an advertisement, will quite naturally be open to this advertisement. An advertiser can count on having advertising broadcast by the trust that users on a buddy list have for each other, on top of which the attention paid to the advertisement should increase. A resource owner can use the resource as an advertising medium without modifying the content of the resource, and can charge an advertising fee to the advertiser.

A second aspect of the present invention presents an advertising device wherein advertisements are broadcast to user-operated, network-interconnected computers, including a first computer operated by a first user and a second computer operated by a second user. This device includes the following:

status administration means for administrating the status of the users including the first user and the second user, and for receiving from the first computer and broadcasting to the second computer the status of the first user;

an advertising database for correlatively recording resource identification information specifying resources on the network with advertising information including image data for the advertisements;

advertising acceptance means for accepting from the computers one selected from

unregistered advertising information to be recorded in the advertising database and designations of already registered resource information included in the resource identification information, and

unregistered resource identification information to be recorded in the advertising database; storing means for storing in the advertising database information accepted by the advertising acceptance means;

resource receiving means for receiving from the first computer first resource identification information specifying a first resource included in the resources the first user is using;

extraction means for extracting from the advertising database first advertising information included in the advertising information and corresponding to the first resource identification information received by the receiving means; and

broadcast means for broadcasting to the second computer the first advertising information extracted by the extraction means.

A third aspect of the present invention presents an advertising device according to the second aspect, wherein the advertising database further stores communications addresses for owners of each resource identification information included in the resource identification information, the advertising device further comprising:

determination means for determining whether, when the advertising acceptance means has accepted from the computers the unregistered advertising information and a designation for the already registered resource identification information, the owner of the unregistered advertising information is identical with the owner of the already registered resource identification information;

inquiry means for inquiring, pursuant to the results of the determination by the determination means, whether the unregistered advertising information may be correlated with the already registered resource identification information, the inquiry to be made using a communication address for the owner of the already registered resource identification information; and

response receiving means for receiving a response to the inquiry, and in accordance with the response delivering the designation of the already registered resource identification information and the unregistered advertising information to the storing means.

Conceivable communication addresses include email address and phone numbers. Resource owners are Web content owners, multimedia data owners, application marketers, and the like. In the event that the owner of a resource and the advertiser wishing to correlate advertising information with that resource are not the same, the communications address is used to obtain the prior consent of the resource owner to correlate the advertising information. The same applies when the owner of advertising information already correlated with a resource wishes to change that advertising information.

A fourth aspect of the present invention presents an advertising device according to the second aspect, wherein:

advertising information included in the advertising information further includes detailed identification information specifying detailed information on the network defining detailed advertising content;

the advertising database further records the detailed identification information; and

the advertising acceptance means further accepts the detailed identification information along with a designation for already registered advertising information stored in the advertising database or along with the unregistered advertising information.

An example of detailed information is Web content giving product information and price for an advertised article. An example of detailed identification information is the URL for that Web content. If detailed identification information is included in advertising information, when a second user clicks on advertising that has been broadcast, a Web browser on the second computer can access the linked URL. Detailed information of the broadcast advertising is thereby displayed on the second computer. Therefore, the second user, to whom the advertising was broadcast, can use the advertisement icon displayed as first user status to easily learn details about the advertising.

A fifth aspect of the present invention presents an advertising device according to the fourth aspect, further comprising notification means, for accepting requests for access to detailed information corresponding to the first advertising information from the second computer, determining whether or not detailed identification information contained in the first advertising information is stored in the advertising database and if not stored, notifying the second computer to that effect.

A sixth aspect of the present invention presents an advertising device according to the fourth aspect, further comprising:

an access database storing computer identification information, detailed identification information, and access counts or access frequencies from a computer to detailed information; and

access database update means determining whether or not the second computer has accessed a first detailed information specified by a first detailed identification information included in the first advertising information and in response to the determination results updating the access database.

Each time a user accesses detailed information, the total access counts or the access frequencies to that detailed information is updated. From this can be learned the extent to which a computer is viewing detailed information, or the extent to which detailed information is being accessed by computers.

A seventh aspect of the present invention presents an advertising device according to the sixth aspect, further comprising:

an incentive database recording the detailed identification information, incentive information specifying incentives to be awarded to the user group, and award conditions for awarding the incentives; and

incentive awarding means for consulting the access database and the incentive database, determining whether or not the first computer has fulfilled any of the award conditions, and if fulfilled, sending to the first computer incentive information correlated with any such fulfilled award condition.

An example of award conditions for awarding an incentive would be awarding an incentive to a second user whose access count for a certain detailed information has reached b 50 times a coupon for exchange for a mouse pad, and to a second user whose access count has reached 100 times a coupon for exchange for a mouse. Incentive information could be, for example, electronic data for the coupon for exchange. Incentive information incentiveing means could be, for example, sending the electronic data by email. Granting incentives to a second user who frequently views detailed information can be expected to increase user participation in a status administration system wherein advertising is displayed in correspondence to user status. And granting incentives to a first user who has given permission to the setting of an advertisement in correspondence to user status in accordance with the numbers of advertisements set and the access counts of a second user can be expected to further increase user participation in a status administration system.

An eighth aspect of the present invention presents an advertising device according to the sixth aspect, further comprising:

an advertising fee database storing access counts or access frequencies, and advertising fees corresponding to the access counts or access frequencies; and

advertising fee calculation means for consulting the access database and the advertising fee database, calculating the access count sum total or the access frequencies to the first detailed information, and reckoning in response to the calculation results advertising fees for the first advertising information.

Let us say, for example, that the advertising fee database stores the information that if the access count for one month is 50 or greater but less than 100, the advertising fee is 1,000 yen, and that if it is 100 or greater, the fee is 3,000 yen. If the access count sum total to a certain detailed information is 60 times in one month, the advertising fee for the advertisement to which that detailed information is related will be 1,000 yen. Through the use of this advertising device, the manager of the advertising device can obtain advertising fees.

A ninth aspect of the present invention presents an advertising program for making function a computer that broadcasts advertisements to computers on a network, operated by users, including a first computer operated by a first user and a second computer operated by a second user. This program makes the computer function as:

status administration means administrating the status of the users including the first user and the second user, and for receiving from the first computer and broadcasting to the second computer the status of the first user;

an advertising database correlatively recording resource identification information specifying resources on the network with advertising information including image data for the advertisements;

advertising acceptance means for accepting from the computers one selected from unregistered advertising information to be recorded in the advertising database and designations of already registered resource information included in the resource identification information, and

unregistered resource identification information to be recorded in the advertising database;

storing means for storing in the advertising database information accepted by the advertising acceptance means;

resource receiving means receiving from the first computer first resource identification information specifying a first resource included in the resources the first user is using;

extraction means for extracting from the advertising database first advertising information included in the advertising information and corresponding to the first resource identification information received by the receiving means; and

broadcast means for broadcasting to the second computer the first advertising information extracted by the extraction means.

This advertising program may be recorded on a computer-readable medium, or it does not have to be recorded. A computer-readable recording medium on which this program is recorded is included in the present invention. Media that can be used include computer-readable and writable floppy diskettes, semiconductor memory, CD-ROM, DVD, MO, and others.

A tenth aspect of the present invention presents an advertising display method for utilization by user-operated, network-interconnected computers, including a first computer operated by a first user and a second computer operated by a second user. This method includes:

a status broadcast step of transmitting from the first computer to an advertising computer administrating the status of users including the first user and the second user the status of the first user for allowing broadcast to the second computer;

a resource detection step detecting resource identification information specifying a first resource, the first user is using, being a resource on the network;

a resource transmission step of transmitting to the advertising computer a first resource identification information detected in the resource detection step;

an advertising reception step of receiving from the advertising computer a first advertising information relating to the first resource identification information and including advertising image data; and

an advertising display step of displaying as the first user status the advertising image data included in the first advertising information.

This method is applied to a user terminal in the advertising method in the above first aspect of the present invention.

An eleventh aspect of the present invention presents advertising method using a status information administration system wherein a plurality of user terminals is interconnected over a network, information on user status sent from one of a plurality of user terminals is acquired and administrated for each user, look-up requests for status information designating at least one user are received, and administrated user status information correlated with the user and administrated is sent to the requestor user terminals. This method includes the following process steps A to C:

A: a step of detecting information identifying a network resource requested from one of the plurality of user terminals, and correlatively recording the detected information with user information identifying a user using the user terminal;

B: a step of accepting a status information look-up request designating at least one user from one of a plurality of user terminals, acquiring network resource identification information correlatively recorded with the user designated by the status information request, and acquiring and sending to the look-up requester user terminal advertising data correlatively stored for each network resource on receiving requests in advance from an advertiser terminal device; and

C: a step of updating advertising data look-up conditions for each consulting user or for each advertising data item, and, in accordance with the look-up conditions, generating incentive information for a user and reporting it to the user, or calculating an advertising fee for an advertiser and reporting invoice data on the advertising fee to the advertiser's terminal, when it is detected in the requester user terminal that the advertising data has been consulted.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a block diagram of an advertising system relating to the present invention;

FIG. 2 is a general view of the flow of advertising broadcast process in the advertising system;

FIG. 3 is a conceptual diagram for explaining the information stored in the advertising database of FIG. 1;

FIG. 4 is a conceptual diagram for explaining the information stored in the user database of FIG. 1;

FIG. 5 is a flowchart showing the flow of advertising database registration process relating to the first embodiment;

FIG. 6 is a flowchart showing the flow of advertising extraction process relating to the first embodiment;

FIG. 7 is a flowchart showing the flow of browse URL transmission process relating to the first embodiment;

FIG. 8 is a flowchart showing the flow of advertising display process relating to the first embodiment;

FIG. 9A is an example of a screen displayed at the user terminal 2b;

FIG. 9B is an example of advertisement icons displayed at the user terminal 2a;

FIG. 10 is a conceptual diagram for explaining the information stored in the advertising database in an advertising system relating to the second embodiment;

FIG. 11 is an example of advertisement icons displayed at a user terminal in the second embodiment;

FIG. 12 is a block diagram of the advertising system relating to the third embodiment;

FIG. 13 is a conceptual diagram for explaining the information stored in the advertising database of FIG. 12;

FIG. 14 is a conceptual diagram for explaining the information stored in the user database of FIG. 12;

FIG. 15 is an example of advertisement icons displayed at a user terminal in FIG. 12;

FIG. 16 is a block diagram of the advertising system relating to the fourth embodiment;

FIG. 17 is a conceptual diagram for explaining the information stored in the advertising database of FIG. 16;

FIG. 18 is a conceptual diagram for explaining the information stored in the user database of FIG. 16;

FIG. 19 is a block diagram of the advertising system relating to the fifth embodiment;

FIG. 20 is a conceptual diagram for explaining the information stored in the incentive database of FIG. 19;

FIG. 21 is a conceptual diagram for explaining the information stored in the access database of FIG. 19;

FIG. 22 is a flowchart showing the flow of incentive process performed by the advertising system of FIG. 19;

FIG. 23 is a block diagram of the advertising system relating to the sixth embodiment; and

FIG. 24 is a conceptual diagram for explaining the information stored in the advertising fee database of FIG. 23.

### DETAILED DESCRIPTION OF THE PREFERRED EMBODIMENTS

Embodiments will be used to explain in detail an advertising system wherein the advertising method of the present invention has been applied.

Buddy List System

An explanation will first be given of a buddy list system that uses this advertising system. A buddy list system is made up of a buddy server administrating user status information and a plurality of buddy clients interconnected over a network.

User A uses a buddy client a to register information relating to his own status on the buddy server. At this time, user A can also set the disclosure level of his registered status information. User A can also register other users whose status he wants to check on the buddy server. These users are called a buddy list.

A buddy server correlates with user A user A's status information and disclosure level, and stores this correlated information. This correlated information is notified from the buddy client a. In addition, based on the buddy list notified from the buddy client a, the buddy server stores the fact that user A has asked for the broadcast of status information of users B, C, D, etc. who are registered on the buddy list. When the buddy server receives user A's status information, as described above, it correlates this with user A and stores this correlated information and it notifies user A's status information recipients of the updated status information.

Meanwhile, buddy client a updates the displayed status information of users B, C, D, etc. If the buddy client a has not been activated, then when it is activated it acquires from the buddy server and displays the latest status information of users B, C, D, etc.

In short, with a buddy list system, if a user registers his own status and users in whom one is interested in as buddies, the buddy client displays the status of buddies on the user's terminal. In addition, when status information of buddies being referenced is changed, status information displayed on the user terminal is automatically updated. A user, by connecting to the buddy server and registering a buddy list, can easily reference the status of buddies he wants to know about.

User status is displayed as characters or objects such as status icons. Status icons are supplied by the supplier of the buddy list system, and can be downloaded to a user terminal as needed.

Overview of the Invention

First, the constitution and the process flow of an advertising system relating to the present invention will be explained.

Overall Configuration

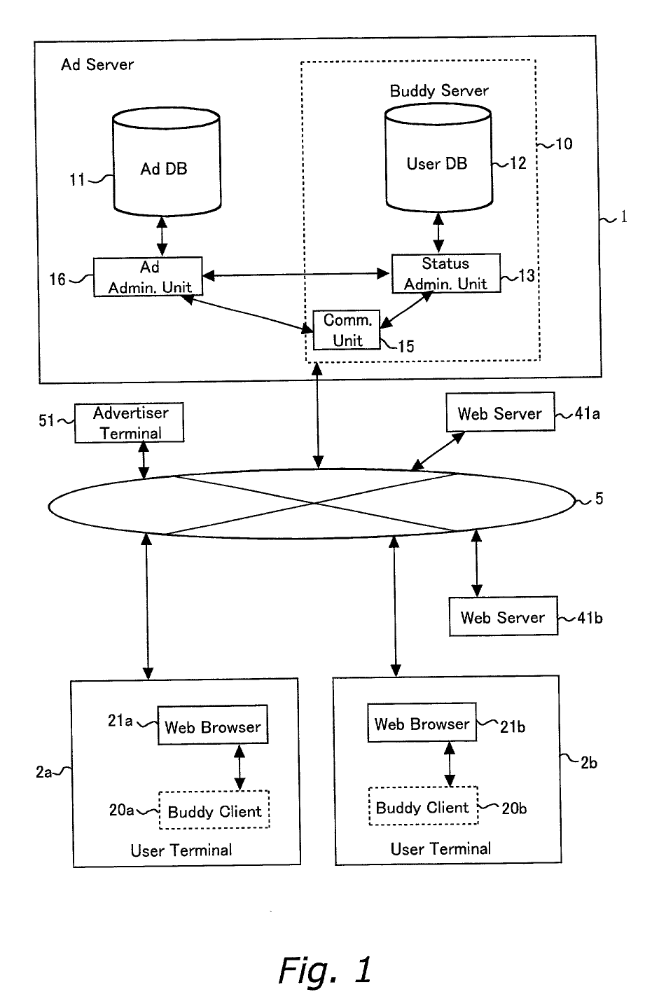

FIG. 1 is a block diagram of an advertising system using a buddy list system. This system is made up of an advertising server 1, user terminals 2a and 2b used by user A and user B, respectively, Web servers 41a and 41b, and an advertiser terminal 51, which are interconnected over a network 5, such as the Internet.

The advertising server 1 includes an advertising database (DB) 11 storing advertisements and a buddy server 10. The buddy server 10 has a user database (DB) 12, which stores user status. The user terminals 2a and 2b have a buddy client 20a and buddy client 20b and a Web browser 21a and Web browser 21b. The Web server 41b may be a file server storing multimedia files.

Process Flow

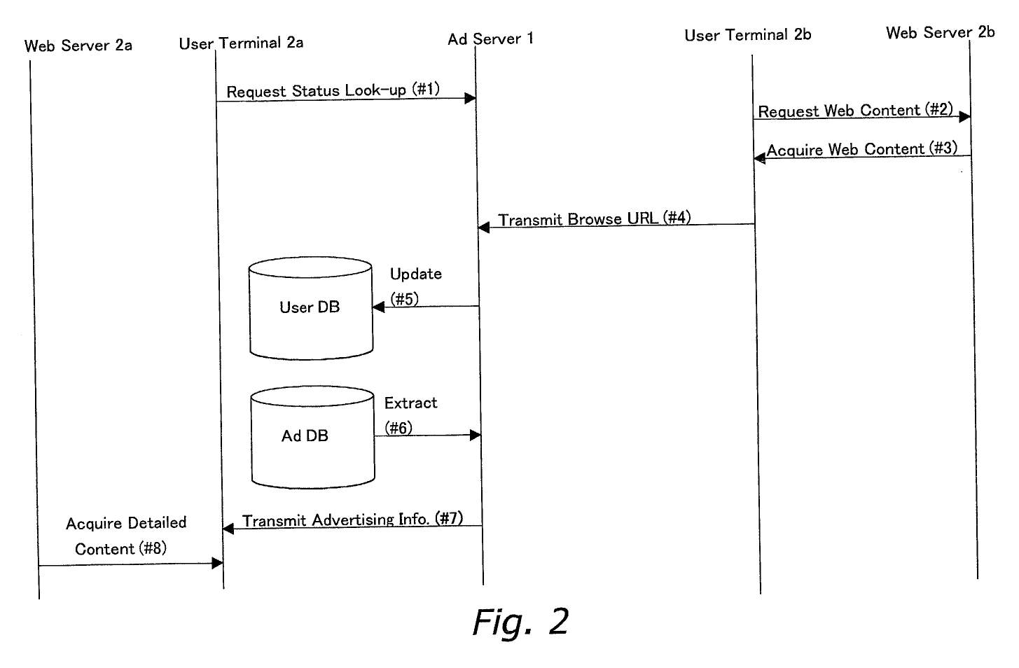

FIG. 2 explains the process flow in the advertising system overall. The advertising system conducts advertising registration process and advertising broadcast process.

Advertising Registration Process

In advertising registration process, the advertising server 1 accepts from the advertiser terminal 51 a designation of an URL correlated with an advertisement (hereinafter “advertisement URL”) and advertising information. This advertising information includes at least advertisement icon image data. The advertising information may also include a hyperlink to the URL of a Web page presenting more detailed advertising (hereinafter “URL for Details”). The advertising server 1 correlates the received advertising information with the designated advertisement URL and stores this in the advertising DB 11.

Advertising Broadcast Process

Carried out in the advertising broadcast process are: (1) a browse URL transmission process, in which the URL for the Web content being displayed on a user's terminal (simply “browse URL” hereinafter) is transmitted to the advertising server 1; (2) an ad extraction process in which advertising is extracted from the advertising DB 11; and (3) an advertising display process.

First, the user terminal 2a connects to the advertising server 1 and asks to see the status of user B, a buddy (#1). This allows the status of user B to be seen at the user terminal 2a.

Meanwhile, user terminal 2b uses the Web browser 21b to request acquisition of the Web content specified by the URL www.fujitaro.com (#2); it acquires this from the Web server 41b and displays it (#3).

Then the user terminal 2b notifies the advertising server 1 of the URL being browsed, i.e., www.fujitaro.com (#4).

The advertising server 1 receives the browse URL and stores this in the user DB 12 (#5). Then the advertising server 1 extracts from the advertising DB 11 the advertising information correlated with the browse URL that it has received (#6). The extracted advertising information is sent to the user terminal 2a as user B status (#7).

Having received this advertising information, the user terminal 2a displays user B's status as an advertisement icon. If a hyperlink to an URL for details is embedded in the advertisement icon, by doubleclicking on the advertisement icon, the user terminal 2a acquires from the Web server 41a the Web content correlated with the URL for details (#8).

First Embodiment

The advertising system using a buddy list system will be explained in further detail.

Configuration

(1) Configuration of the Advertising Server

The constitution of the advertising server 1 will be explained, referring again to FIG. 1. The advertising server 1 has an advertising DB 11 and an advertisement administration unit 16 in addition to a buddy server 10. The buddy server 10 has a user DB 12, a status administration unit 13 and a communications unit 15. First the advertising DB 11 and the user DB 12 will be explained.

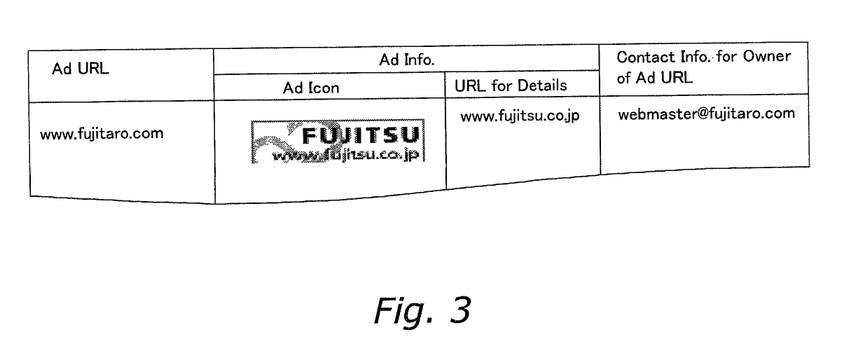

FIG. 3 is a conceptual diagram for explaining the information stored in the advertising DB 11. In this example, the advertising DB 11 stores advertisement URLs, advertisement icons, URL for details and contact information for owners of the advertisement URLs. “Advertisement icon” and “URL for Details” make up advertising information.

As explained above, “Advertisement URL” represents the URL for the Web content with which an advertisement is correlated. “Advertisement icon” represents advertisement icon image data file for the advertiser (hereinafter “icon file”). In place of the icon file itself, the address where an icon file is stored or an icon identifier may be stored as the advertisement icon.

As explained above, “URL for Details” is the URL for the Web page on which detailed advertising content is posted. “Contact Information for Owner of Advertisement URL” is the contact information for the owner of the Web content specified by the advertisement URL. In this embodiment, an email address is used as the contact information.

In this embodiment, “Advertisement URL” and “Contact Information for Owner of Advertisement URL” are registered by the advertising server manager.

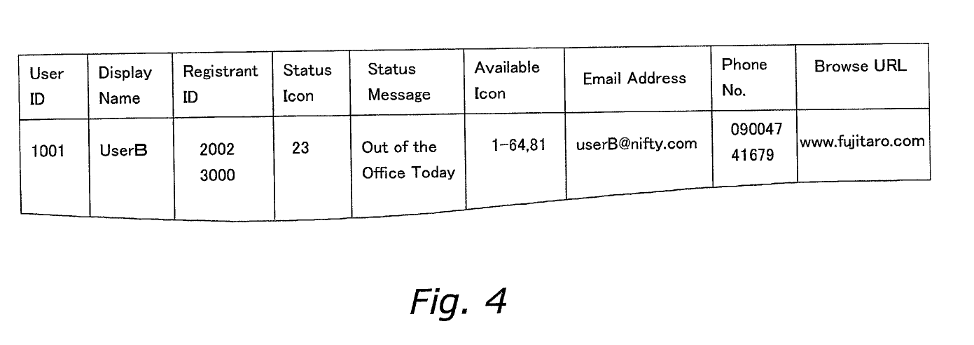

FIG. 4 is a conceptual diagram for explaining the information stored in the user DB 12. In this example, the user DB 12 stores user IDS, display names, registrant IDS, status icons, status messages, available icons, email addresses, telephone numbers, and browse URLs. “User ID” is an identifier for specifying a user on the buddy system and advertising system. “Display Name” is a display name showing the user specified by the user ID in an easy-to-understand manner. “Registrant ID” is the user ID of buddies registered on the buddy list. “Status Icon” is a status icon ID specifying a status icon showing the current status of a user. “Status Message” is text data showing user status. “Available Icon” is an identifier for status icons that can be displayed on a user terminal. “Email Address” is the email address for users. “Telephone Number” is the telephone number of users. “browse URL” is, as explained above, the URL for the Web content currently being viewed by a user using a Web browser.

The status administration unit 13 receives from the user terminal 2b update notifications of user status, and updates the user DB 12. The status administration unit 13 also updates the user DB 12 based on notifications from the user terminal 2b of the browse URL. The status administration unit 13 also requests and acquires from the advertisement administration unit 16 the advertisement icon and the URL for details corresponding to the browse URL by the user terminal 2b (hereinafter, collectively “advertising information”). And the status administration unit 13 transmits the advertising information to user A's user terminal 2a, for which user B is registered as a buddy.

The advertisement administration unit 16 accepts registration of advertising information from the advertiser terminal 51 and stores the advertising information in the advertising DB 11. The advertisement administration unit 16 also accepts requests for advertising information from the status administration unit 13, and using the browse URL as a key, extracts the advertising information from the advertising DB 11.

The communications unit 15 transmits data between the user terminal 2a and the user terminal 2b.

(2) Configuration of User Terminal

The user terminals 2a and 2b have buddy clients 20a and 20b, and Web browser 21a and Web browser 21b, respectively. The buddy clients 20a and 20b ask the advertising server 1 for buddy status, and receive and display the same. When user status is updated, the buddy clients 20a and 20b transmit this to the advertising server 1. The buddy clients 20a and 20b also monitor changes in the browse URL, and when the browse URL is updated, they transmit the new browse URL to the advertising server 1.

The Web browsers 21a and 21b access the Web servers 41a and 41b and acquire and display the Web content specified by an URL.

Process Flow

The process flows of the advertising server 1 and user terminals 2a and 2b, having the above-described functions, will be explained.

(1) Process in the Advertising Server

The advertising server 1 performs the above-described advertising registration process and the advertising extraction process in the advertising broadcast process.

(1-1) Advertising Registration Process

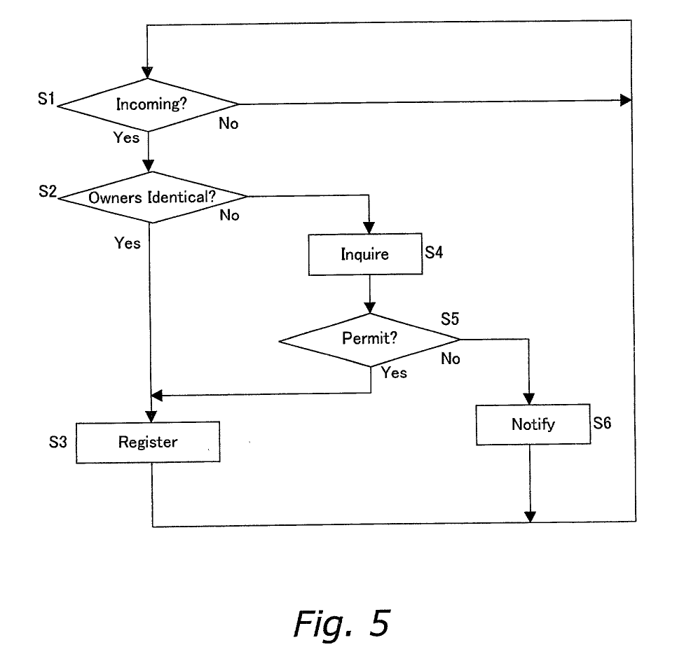

FIG. 5 is a flowchart showing the flow of advertising registration process in the advertising system. In this process, the advertising server 1 registers the advertisement icon and URL for details sent from the advertiser terminal 51 in the advertising DB 11.

Step S1: The advertising server 1 waits for a registration request from the advertiser terminal 51 to register advertising information. This registration request includes a designation for an advertisement URL correlated with an advertisement. For example, an advertiser follows a registration form posted on a Web page and inputs an advertisement URL and advertising information. The registration form may be constituted to present a list of advertisement URLs previously registered in the advertising DB 11, allowing the advertiser to designate an advertisement URL. The registration form may also be constituted so that only advertisement icons can be registered thereon. And it may be constituted to accept additional registrations for URLs for details corresponding to previously registered advertisement icons, as well as changes thereto.

Step S2: The advertising server 1 determines whether the owner of the advertisement URL and the owner of the URL for details are the same. For example, if the third-level domain name of the advertisement URL and the third-level domain name of the URL for details are the same, it judges that the owners are the same; if they aren't the same, it judges that the owners aren't the same. If it judges “the same,” then administration proceeds to Step S3; if it judges “different,” then administration proceeds to Step S4, explained later.

Step S3: The advertising server 1 correlates the advertising information it has received, i.e., the advertisement icon and the URL for details, with the designated advertisement URL, and registers this in the advertising DB 11.

Step S4: The advertising server 1 asks the owner of the advertisement URL whether it may correlate the advertising information therewith. Specifically, one way this can be performed is to send to the contact address of the advertisement URL owner an email with the URL for a Web page for inputting whether permission for correlating is granted or not. An advertisement URL owner, having received this email, responds to the inquiry by accessing the Web page and inputting whether permission to correlate is granted or not.

Step S5: The advertising server 1 waits for the response from the aforementioned advertisement URL owner, and determines whether permission to correlate has been granted or not. If permission is granted, administration proceeds to Step S3; if permission is denied, administration proceeds to Step S6.

Step S6: The advertising server 1 sends notification to the advertiser terminal 51 by, for example, email, to the effect that permission to correlate the advertisement was not granted. In such a case, the advertising information is not registered in the advertising DB 11.

(1-2) Advertising Extraction Process

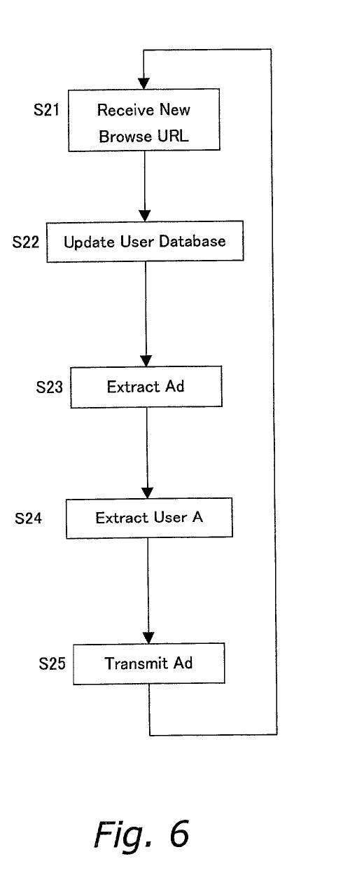

FIG. 6 is a flow chart showing the advertising extraction process portion of the above-described advertising broadcast process. In this process, the advertising server 1 extracts from the advertising DB 11 the advertising information corresponding to the browse URL.

Step S21: The status administration unit 13 receives from the user terminal 2b user ID “1001” and a new browse URL.

Step S22: The status administration unit 13 uses the user ID it has received, i.e., “1001,” as a key to search the user DB 12, and updates the browse URL of the corresponding entry.

Step S23: The status administration unit 13 delivers the browse URL that it has received to the advertisement administration unit 16. The advertisement administration unit 16 searches the advertising DB 11 for the advertisement URL that matches the browse URL, and delivers to the status administration unit 13 advertising information corresponding to the advertisement URL for which there were hits.

Step S24: The status administration unit 13 extracts from the user DB 12 user A, who has registered as a registrant ID user ID “1001,” i.e., the user ID received in Step S21.

Step S25: The status administration unit 13 transmits to the user terminal 2a the advertising information and user B user ID “1001” to the user terminal 2a, whereupon an advertisement icon is displayed in correspondence to user B.

(2) Process at User Terminals

User terminals 2a and 2b conduct browse URL transmission process and advertising display process during the above-described advertising broadcast process.

(2-1) Browse URL Transmission Process

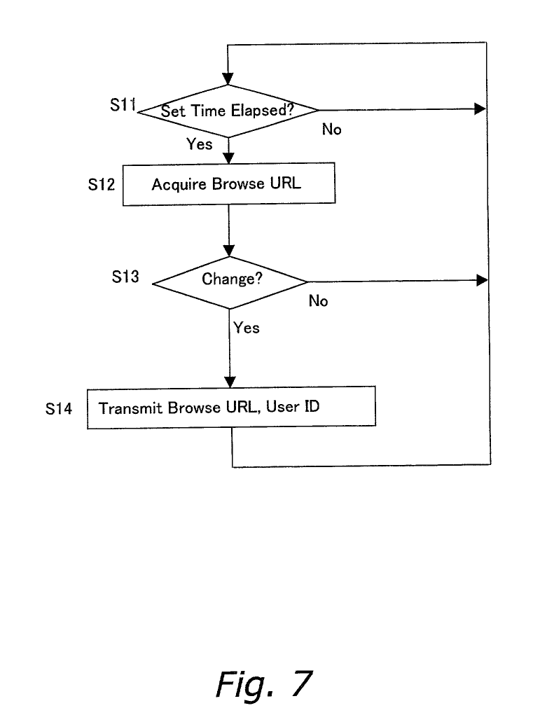

FIG. 7 is a flowchart showing the flow of browse URL transmission process conducted by the buddy clients 20a and 20b of the user terminals 2a and 2b. In this process, the user terminals 2a and 2b monitor changes in URLs being viewed, and when a browse URL changes, they transmit the new browse URL to the advertising server 1. In this embodiment, the user terminal 2b transmits browse URL www.fujitaro.com to the advertising server 1.

Step S11: The buddy client 20b waits for the elapse of a set amount of time, e.g., five minutes; when five minutes pass, administration proceeds to Step S12.

Step S12: The buddy client 20b acquires the browse URL from the Web browser 21b.

Step S13: The buddy client 20b determines whether the browse URL acquired in Step S12 is different from the previously acquired browse URL. If it determines “yes,” then the value for “previously acquired browse URL” is changed to www.fujitaro.com, the current browse URL. The “previously acquired browse URL” is changed to the current browse URL, www.fujitaro.com, and administration proceeds to Step S14. If the buddy client 20b determines “no,” then administration returns to Step S11.

Step S14: The buddy client 20b transmits the current browse URL, www.fujitaro.com, along with the user ID of the buddy client 20b to the advertising server 1.

(2-2) Advertising Display Process

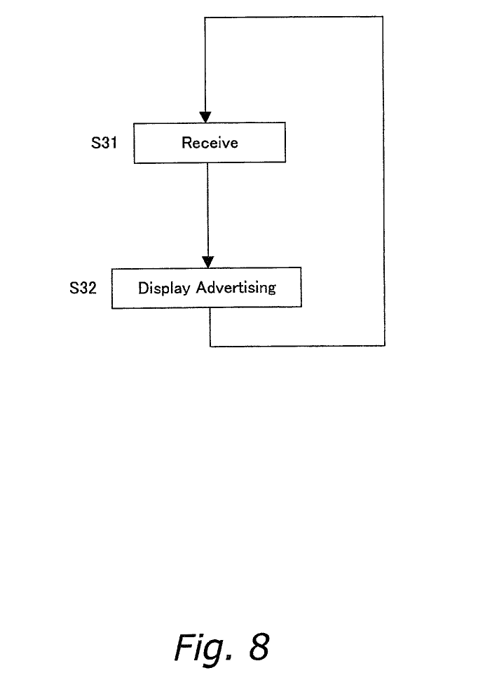

FIG. 8 is a flowchart showing the flow of advertising display process conducted by the buddy clients 20a and 20b of the user terminals 2a and 2b. In this process, the user terminals 2a and 2b receive the latest advertising information corresponding to the browse URL by a buddy and display an advertisement icon. In this embodiment, the user terminal 2a displays an advertisement icon corresponding to the browse URL by user B, www.fujitaro.com.

Step S31: The buddy client 20a receives the user ID of user B, a buddy, and advertising information corresponding to the browse URL, www.fujitaro.com. The receive timing is either when the buddy client 20a connects to the advertising server 1 and requests buddy status, or when a change of browse URL by user B is registered with the advertising server 1.

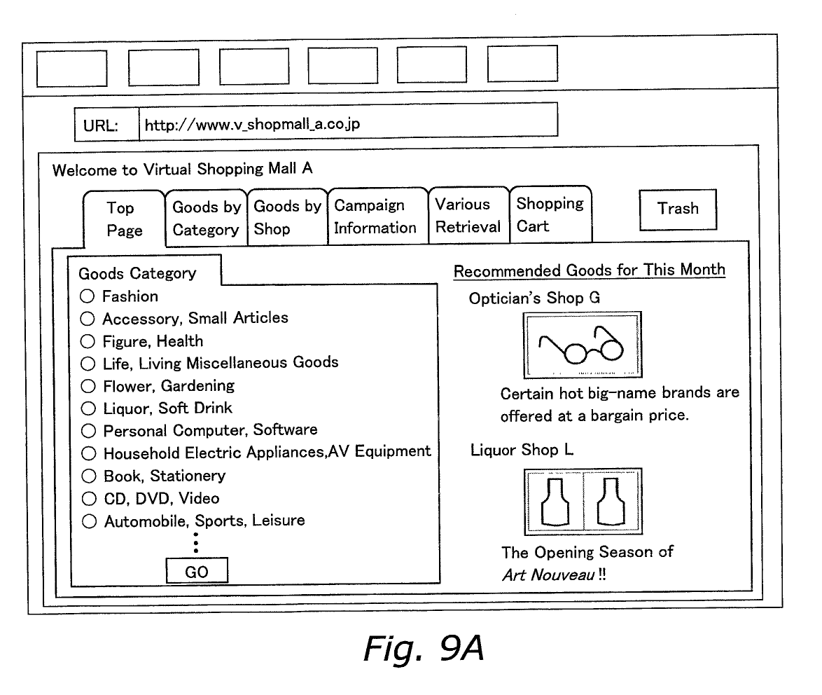

Step S32: The buddy client 20a extracts the advertisement icon from the advertising information, correlates this with the status of the buddy specified by the user ID, and displays the advertisement icon (see FIG. 9(B) below).

Screen Shot

FIG. 9 shows an example of an advertisement icon being displayed on the user terminal 2a in correspondence to user B's Web content viewing status. FIG. 9A is an example of the Web content that user B is viewing using the Web browser 21b. FIG. 9B is an example of the advertisement icon corresponding to the browse URL by user B being displayed along with user B status.

Second Embodiment

For the second embodiment, an explanation will be given of an advertising system wherein a plurality of advertisement icons are broadcast for a single browse URL and advertising text can also be broadcast.

The advertising system relating to this embodiment has the same configuration as that of advertising system relating to the first embodiment. The elements in the figures that have the same indicators as in the first embodiment have the same functions as in the first embodiment.

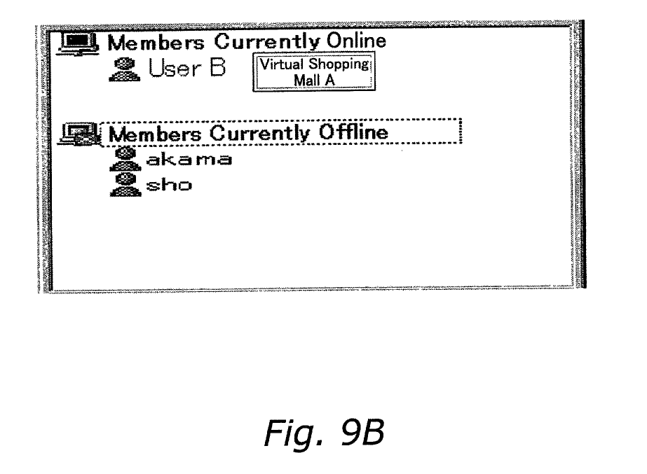

FIG. 10 is a conceptual diagram of the information stored in the advertising DB 11 relating to the second embodiment. The advertising DB 11 of this embodiment, in addition to advertisement URLS, advertisement icons and URL for details, also stores advertising text and registration time and date of advertising information. In addition, the advertising DB 11 can correlate a plurality of advertising information for a single advertising URL, and store these.

In an advertising system having the above-described configuration, advertising registration process and advertising broadcast process are conducted in the same manner as in the first embodiment. However, the advertisement administration unit 16 of the advertising server 1 has the further function of determining which advertising information to broadcast from among the plurality of advertising information extracted in correspondence to a browse URL (not shown in figure). There are no restrictions on which advertising information can be broadcast to the user terminal 2. For example, all advertising information may be broadcast, or just the advertising information having the latest registration date may be broadcast. Or all advertising information may be broadcast with their registration date and time attached.

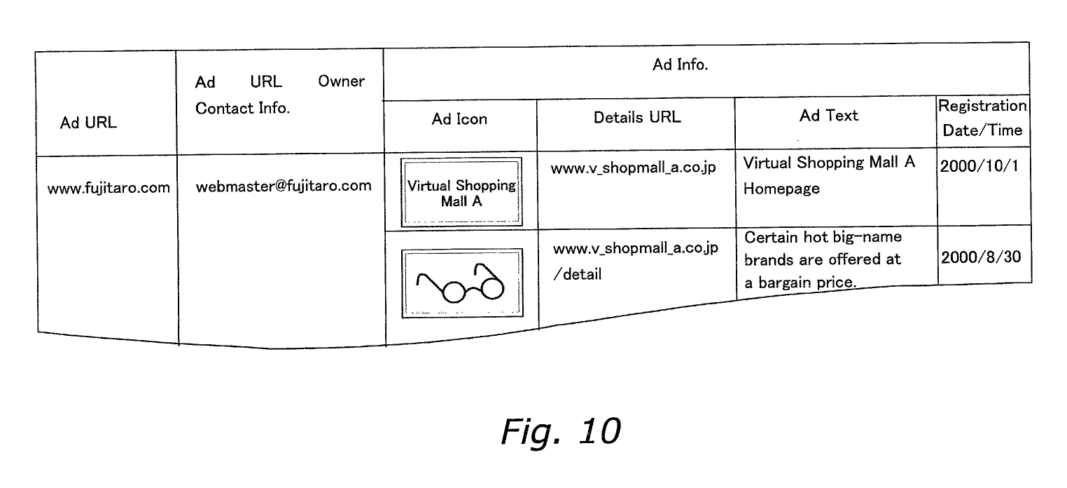

In addition, the buddy clients 20a and 20b of the user terminals 2a and 2b may, when a plurality of advertising information has been broadcast, show an enlarged display of a plurality of advertisement icons. The buddy clients 20a and 20b may also receive a plurality of advertising information along with their registration date and time, display the latest advertisement icon along with its user status, and show an enlarged display of all the other advertisement icons in a separate display region (see FIG. 11 below). When an ad icon has been selected, the buddy clients 20a and 20b cause the advertising text included in the advertising information to be displayed on the screen.

Screen Shot

FIG. 11 is an example of a display of advertisement icons and advertising text when a plurality of advertising information corresponding to the browse URL by user B is broadcast to the user terminal 2a. An advertisement icon 201, which is displayed along with user B's status, corresponds to the advertising information with the latest registration time in the advertising DB 11. At the bottom of the display screen of the user terminal 2a are enlarged displays of advertisement icons 201 and 202, which are all the advertisement icons corresponding to the browse URL. In this example, one of the two advertisement icons, the advertisement icon 201, represents the owner of the browse URL, and the other icon, the advertisement icon 202, shows a product that the owner of the browse URL recommends. The advertisement icon 202, which is shown in an enlarged display, has been selected, and the advertising text corresponding thereto is displayed in an advertising text display region 203.

Third Embodiment

For the third embodiment, an explanation will be given of an advertising system wherein advertisement icons are displayed according to what files, such as mp3 format music files, a user is using.

Configuration

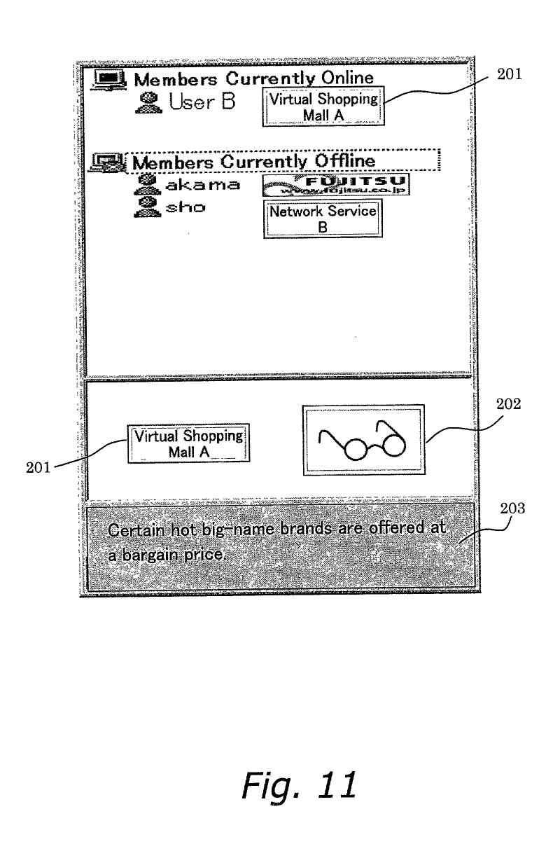

FIG. 12 is a block diagram of the advertising system relating to the third embodiment. In this figure, elements with the same indicators as in the first embodiment have the same functions as in the first embodiment. However, the Web server 41b stores multimedia files such as audio files and video files, and the user terminal 2a further includes a multimedia player 22 for replaying multimedia files.

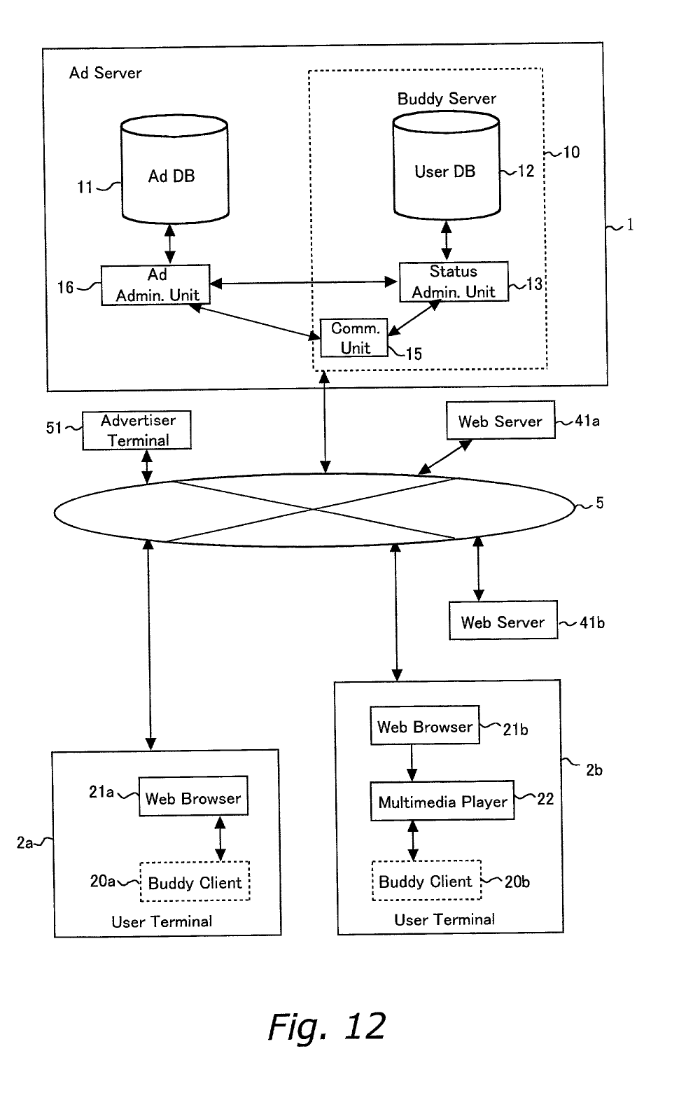

FIG. 13 is a conceptual drawing for explaining the information stored in the advertising DB 11 relating to this embodiment. This advertising DB 11 has the same configuration as the advertising DB 11 according to the first embodiment, except that instead of advertisement URLs, it stores “Advertising File Name,” which is the file name of multimedia files, and instead of advertisement URL owner contact information, it stores “File Originator Contact Information,” which is contact information on the creator of the multimedia file. For example, let us consider a case where “Advertising File Name” is an mp3 file “1075ftaro.mp3,” which includes data for a new tune by singer “Taro Fujitsu.” An advertisement icon displaying the message “New tunes by Taro Fujitsu now on sale” is registered for this advertising file. As the URL for details, an URL is given for a Web site from which the latest tunes of Taro Fujitsu can be downloaded.

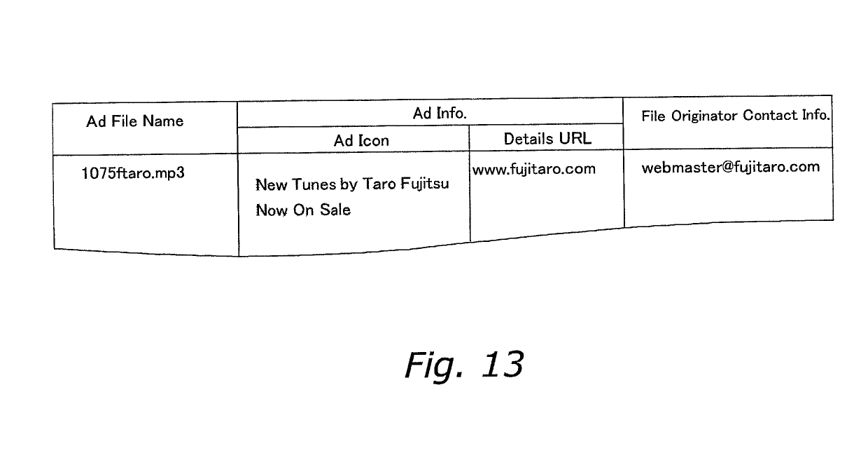

FIG. 14 is a conceptual drawing for explaining the information stored in the user DB 12 relating to this embodiment. This user DB 12 has the same configuration as the user DB 12 according to the first embodiment, except that instead of advertisement URL, it stores “Name of File Being Played.” This “Name of File Being Played” is the name of the multimedia file that a user is currently playing. In this example, user B is playing the multimedia file “1075ftaro.mp3.”

Process Flow

In an advertising system having the above-described configuration, advertising registration process and advertising broadcast process are conducted in the same manner as in the first embodiment. However, in the browse URL transmission process, the buddy client of the user terminal 2 monitors changes in the name of file being played instead of the browse URL, and sends this to the advertising server 1.

Screen Shot

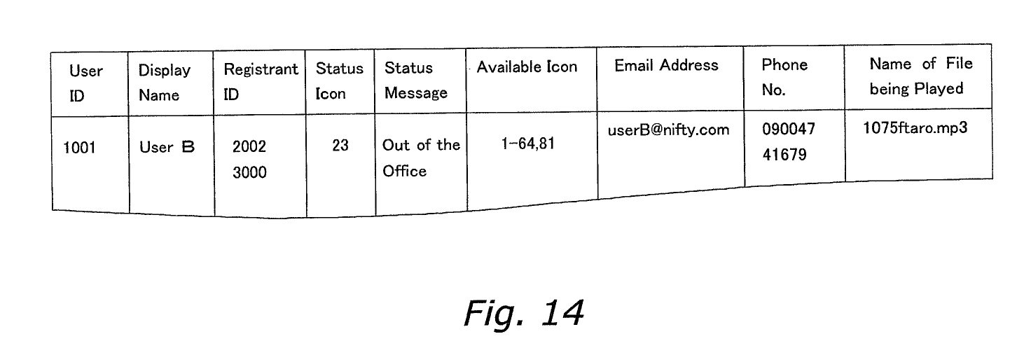

FIG. 15 shows an example of the advertisement icon correlated with the multimedia file being played by user B, i.e., “1075ftaro.mp3,” being displayed at the user terminal 2a along with user B's status. When user A doubleclicks on the advertisement icon, the Web browser 21a accesses a Web site from which Taro Fujitsu's latest tune can be downloaded.

Fourth Embodiment

For the fourth embodiment, an explanation will be given of an advertising system wherein advertisement icons are displayed in accordance with the editor or other application that a user is using at a user terminal.

Configuration

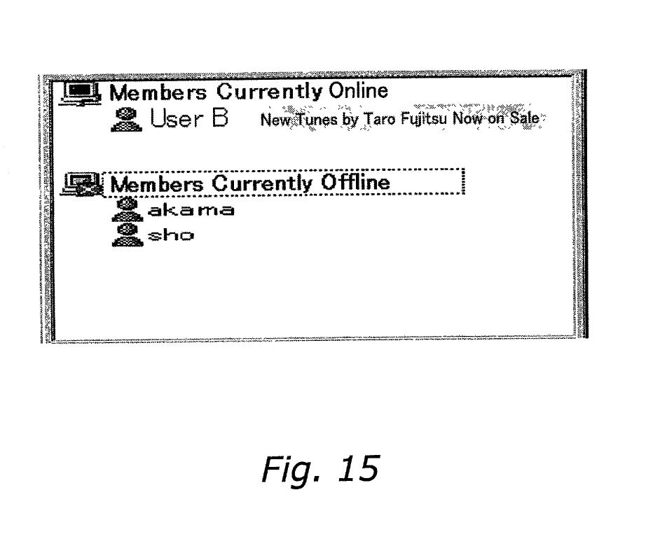

FIG. 16 is a block diagram of an advertising system relating to the fourth embodiment. In this figure, elements with the same indicators as in the first embodiment have the same functions as in the first embodiment. In this embodiment, the user terminal 2b, instead of the Web browser 21b, has application 23, such as an editor.

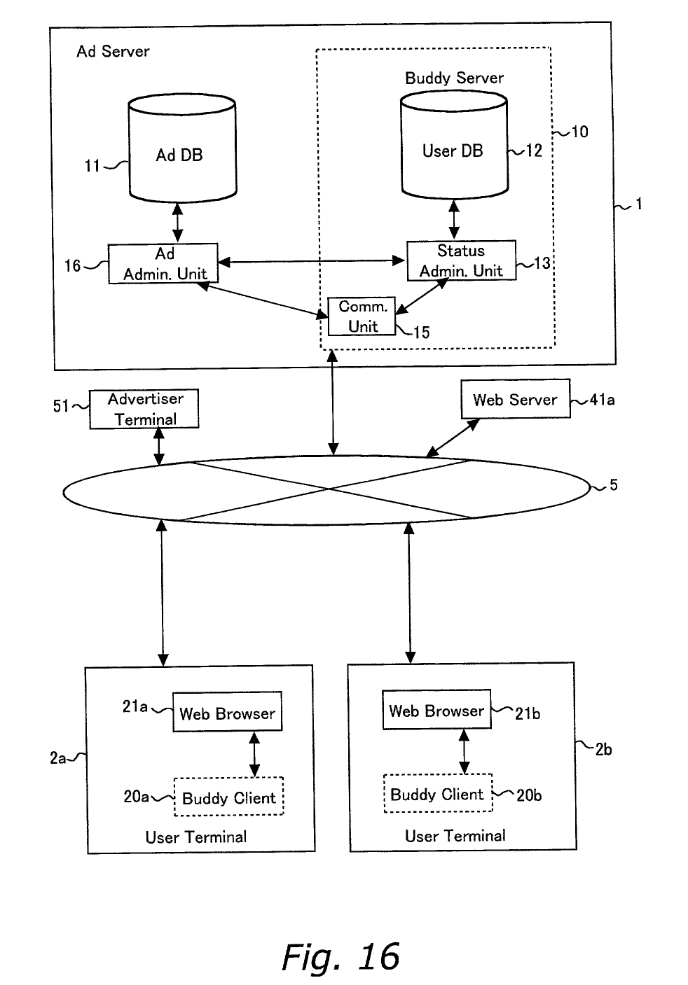

FIG. 17 is a conceptual diagram for explaining the information stored in the advertising DB 11. This advertising DB 11 has the same configuration as the advertising DB 11 in the first embodiment, expect that in place of the advertisement URL, it stores “Advertisement Application Name,” and in place of the contact information for owner of advertisement URL, it stores “Application Producer Contact Information.” Herein, advertised application name is the name of the file containing an application program. For example, let us consider a case where the “Advertisement Application Name” is “chocoa,” Fujitsu's latest IRC client. An advertisement icon with the message “Fujitsu's new chocoa 2 is now on sale” is registered for this advertised application name. As the URL for details therefor, an URL is given for a Web site from which can be downloaded chocoa2, the upgraded version of chocoa.

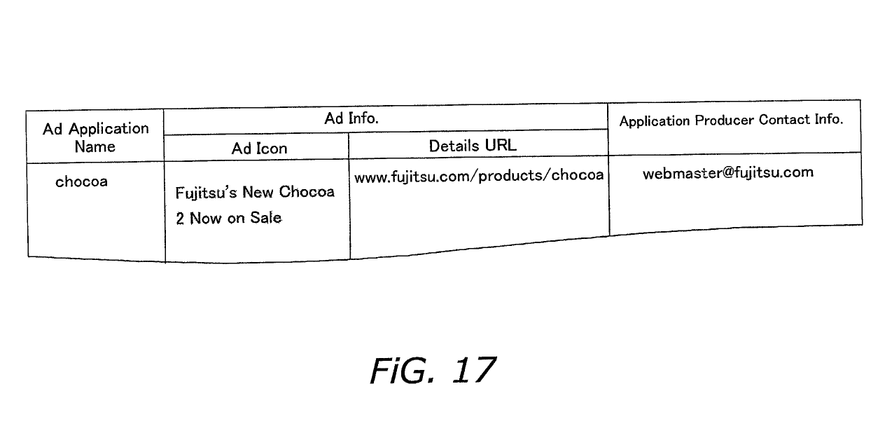

FIG. 18 is a conceptual diagram for explaining the information stored in the user DB 12. This user DB 12 has the same configuration as the user DB 12 in the first embodiment, except that in place of the browse URL, it stores “Name of Application Being Executed.” The “Name of Application Being Executed” is the name of the application being presently executed on the user terminal 2b. In this example, user B is using the IRC client “chocoa.”

Process Flow

In an advertising system having the above-described configuration, advertising registration process and advertising broadcast process are conducted in the same manner as in the first embodiment. However, in the browse URL transmission process, the buddy client of the user terminal 2, monitors changes in the name of application being executed instead of the browse URL, and sends this to the advertising server 1.

For example, if user B has begun use of the IRC application chocoa, the buddy client 20b sends to the advertising server 1 the file name “chocoa.exe,” which is the name of the file storing the chocoa program. An advertisement icon corresponding to chocoa, as well as user B's status, is displayed on the screen of the user terminal 2a (not shown in figure).

Fifth Embodiment

For the fifth embodiment, an explanation will be given of an advertising system that motivates users to participate in the advertising system by providing incentives to users who access URL for details.

Configuration

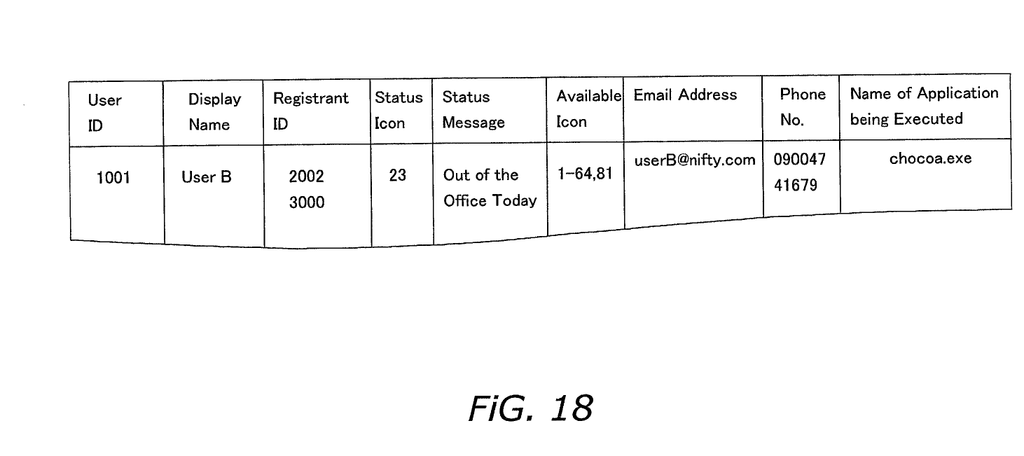

FIG. 19 is a conceptual diagram of an advertising system relating to the fifth embodiment. In this figure, elements with the same indicators as in the first embodiment have the same functions as in the first embodiment. In the advertising system relating to the fifth embodiment, to the configuration of the first embodiment has been added an incentive database 17, an access database 18 and an incentive administration unit 19. The incentive administration unit 19 receives from the advertiser terminal 51 incentive information, which will be explained later, and updates the incentive database 17. The incentive administration unit 19 also updates the access database 18 pursuant to notifications from the user terminals 2a and 2b. The buddy clients 20a and 20b of the user terminals 2a and 2b have the further function of monitoring for access to URL for details and notifying the advertising server 1 when there has been such access (hereinafter “access notification”).

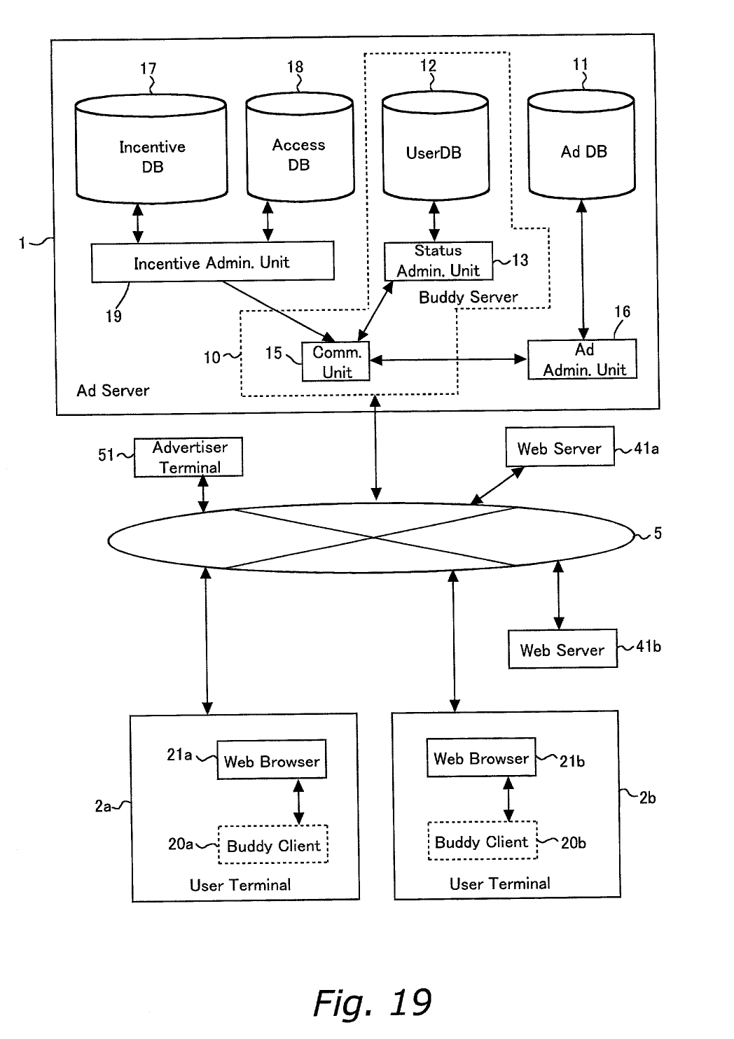

FIG. 20 is a conceptual drawing for explaining the information stored in the incentive database 17. The incentive database 17 stores “Details URL,” “Access Count Standard” and “Incentives” (hereinafter collectively referred to as “incentive information”). Incentives defined in “Incentives” are presented to users who have accessed Web content specified in “Details URL” a number of times equal to or exceeding an access count standard. Incentive information is input from the advertiser terminal 51 and stored in the incentive database 17 by the incentive administration unit 19.

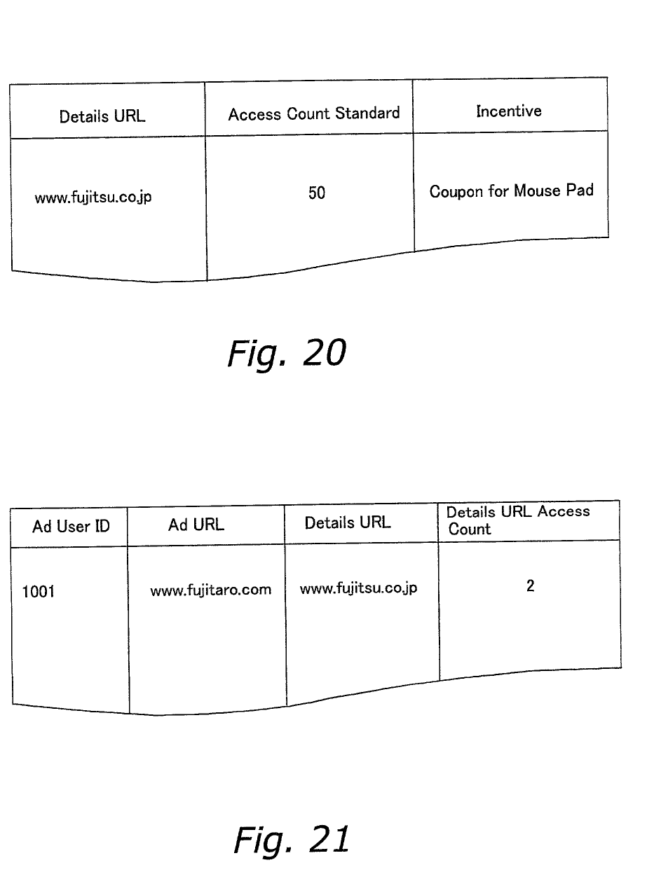

FIG. 21 is a conceptual drawing for explaining the information stored in the access database 18. Stored in the access database 18 are “Advertising User ID,” which is the user ID for a user viewing an URL, “Advertisement URL,” “Details URL,” and “Details URL Access Counts.” “Details URL Access Counts” indicates the number of times the user specified by an “Advertising User ID” has accessed an URL for details.

Process Flow

In the advertising system having the above configuration, advertising registration process and advertising broadcast process are conducted with the same flow as in the first embodiment, and the following incentive process is conducted as well.

Incentive Process

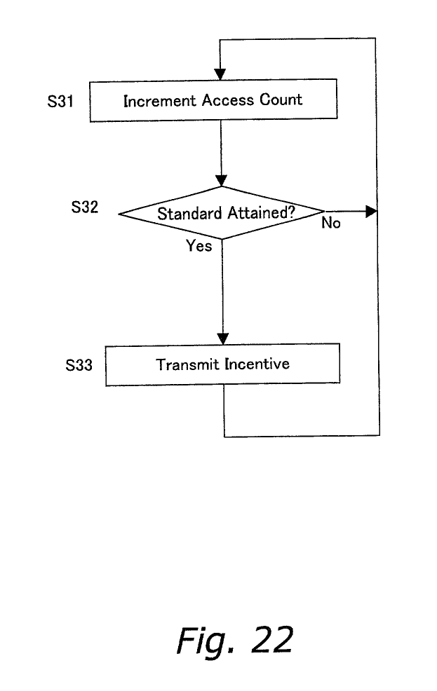

FIG. 22 is a flowchart showing the flow of incentive process conducted by the advertising server 1. In incentive process, when user A has accessed an URL for details a predetermined number of times, user A is awarded an incentive or the like by the advertising server 1.

Step S31: The incentive administration unit 19 awaits notification from the user terminals 2a and 2b of access to an URL for details. If it receives notification from either of the terminals, for example, notification that user terminal 2a has accessed the URL www.fujitsu.co.jp, it searches the access database 18 for an entry where the access counts of the user terminal 2a to www.fujitsu.co.jp are stored. If such an entry exists, the access count is incremented; if no such entry exists, a new entry is created.

Step S32: The incentive administration unit 19 refers to the incentive database 17 and the access database 18 and determines whether the access count to www.fujitsu.com has reached the access count standard stipulated in the incentive database 17. If the standard has been reached, administration proceeds to Step S33. If the standard has not been reached, administration returns to Step S31, and access notification from the user terminals 2a and 2b is awaited.

Step S33: The incentive administration unit 19 notifies user A of the incentive or the like. Conceivable methods of notification include, for example, sending to the user terminal 2a an email with a hyperlink to a Web page on which such an incentive is described.

When user A, having received such notification, uses the Web browser 21a to access the Web page, a coupon for an article is displayed. User A prints this out, brings it to a store, and exchanges it for the article, thereby receiving the incentive. This process can be expected to increase the number of users accessing URL for details and thereby improve advertising effectiveness, by providing users with motivation to participate in this advertising system.

Sixth Embodiment

For the sixth embodiment, an explanation will be given of an advertising system wherein the advertising system manager collects advertising fees from advertisers.

Configuration

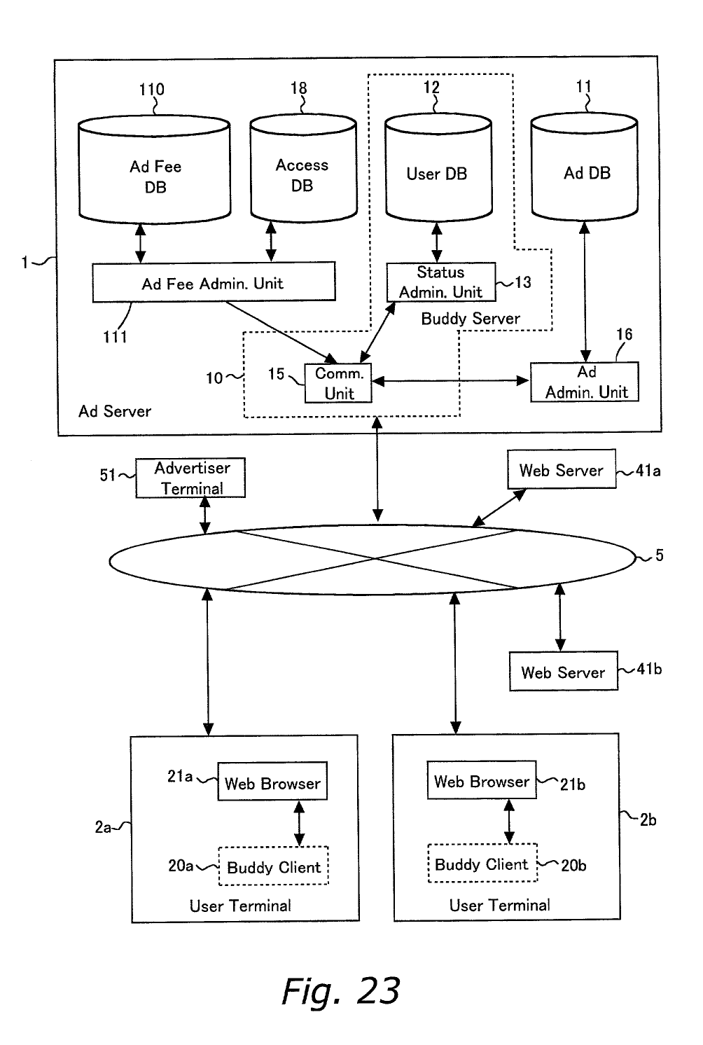

In the fifth embodiment, access count-based incentives were given to users; a similar method can be used to determine advertising fees based on access counts. FIG. 23 is a block diagram of an advertising system relating to the sixth embodiment. This advertising system has, in place of the incentive database 17, an advertising fee DB 110, and in place of the incentive administration unit 19, an advertising fee administration unit 111. In the figure, elements having the same indicator as in the fifth embodiment have the same function as in the fifth embodiment. The advertising fee administration unit 111 accepts from the advertising server 1 operator registration of advertising fees in the advertising fee DB 110 as well as changes to such fees.

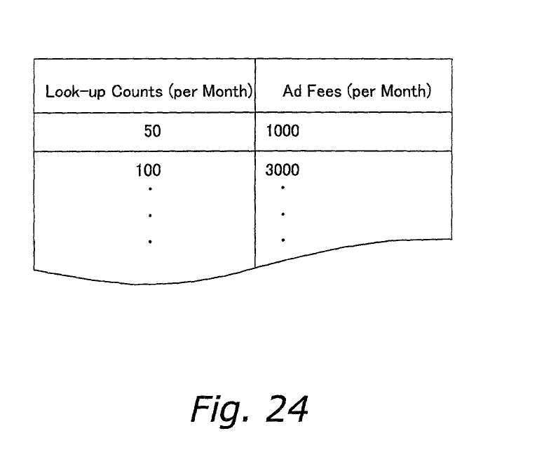

FIG. 24 is a conceptual diagram for explaining the information stored in the advertising fee DB 110. The advertising fee DB 110 stores look-up counts (monthly) and advertising fees (monthly). The advertising fee database is created when the advertising system manager constructs the system.

Process Flow

An advertising system having the above configuration conducts advertising registration process and advertising broadcast process with the same flow as in the first embodiment, and it further conducts advertising fee determination process.

In advertising fee determination process, each time the user terminals 2a and 2b access an URL for details, an advertising fee administration unit 111 increments the URL for details access count in the access database 18. The process for counting access counts is conducted in the same way as Step S31 in the fifth embodiment.

The advertising fee administration unit 111 also, at certain intervals, for example, once a month, checks the access database 18 and an advertising fee database 110, and determines the advertising fee for each URL for details. By using this system, the manager of an advertising system can collect advertising fees from advertisers.

Other Embodiments

(A) In the first embodiment, “Advertisement URLs” and “Contact Information for Owners of Advertisement URLs” are registered by the advertising server manager, but other setups are conceivable. For example, the advertising server 1 may be constituted to use the advertisement administration unit 16 to accept “Advertisement URLs” and “Contact Information for Owners of Advertisement URLs” over a network from owners of advertisement URL content.

(B) In the first embodiment, the changes in the browse URL were monitored by the user terminals 2a and 2b, but other set-ups are possible. For example, the user terminals 2a and 2b send at set intervals the browse URL to the advertising server 1. The advertising server 1 compares the previous browse URL to the latest browse URL, and if there has been a change it extracts advertising information from the advertising DB 11 and sends this.

(C) The first embodiment may be constituted so that, when an advertisement icon on a user terminal is doubleclicked even though an URL for details is not included in advertising information, the advertising server 1 or the buddy clients 20a or 20b notify the user that an URL for details is not registered.

When the advertising server 1 performs this notification, the buddy clients 20a or 20b send to the advertising server 1 designation of the advertisement icon and a request for an URL for details. The advertising server 1 searches the advertising DB 11 for an URL for details corresponding to the designated advertisement icon; if one does not exist, it sends to the user terminals 2a or 2b a message to the effect that an URL for details is not registered.

(D) In the fifth embodiment, incentives are offered to user A, but incentives may be offered to user B too. This is because user B has given permission for the correlation of advertisements with his own status, namely, his accessing of Web content. The number of times an URL for details was accessed through the selection of an ad icon corresponding to user B's status can be counted, and incentives given based on those access counts.

(E) A computer-readable recording medium on which is recorded a program for executing the above-described process is included in the present invention. Examples of such recording media include computer-readable floppy diskettes, semiconductor memory, CD-ROMS, DVDs, MO disks, etc.

Through the use of the present invention, because the broadcast of various types of advertising is effected by users who trust each other, users will be more open to the advertising, leading to more effective advertising.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. An advertising method for broadcasting advertisements to user-operated, network-interconnected computers including a first computer operated by a first user and a second computer operated by a second user, the method including:
a status administration step of administrating status of users including the first user and the second user;
a status broadcast step of receiving from the first computer and broadcasting to the second computer the status of the first user;
a memory step of correlatively recording in an advertising database resource identification information specifying a resource on the network with advertising information including image data for the advertisements;
an advertising acceptance step of accepting from said computers at least one selected from the resource identification information and the advertising information to be recorded by said memory step;
a storing step of storing in said advertising database information received in said advertising acceptance step;
a resource detection step of detecting resource identification information for a first resource in use by the first user;
an extraction step of extracting from the advertising information recorded in said memory step first advertising information corresponding to the resource identification information for the first resource, detected in said detection step;
a broadcast step of broadcasting to the second computer said first advertising information extracted in said extraction step; and
an advertising step for displaying as status of the first user on the second computer advertising image data included in said first advertising information broadcast in said broadcast step.

2. An advertising device for broadcasting advertisements to user-operated, network-interconnected computers, including a first computer operated by a first user and a second computer operated by a second user, the advertising device comprising:
status administration means for administrating the status of users including the first user and the second user, and for receiving from the first computer and broadcasting to the second computer the status of the first user;
an advertising database for correlatively recording resource identification information specifying resources on the network with advertising information including image data for the advertisements;
advertising acceptance means for accepting from the computers one selected from
unregistered advertising information to be recorded in said advertising database and designations of already registered resource information included in the resource identification information, and
unregistered resource identification information to be recorded in said advertising database;
storing means for storing in said advertising database information accepted by said advertising acceptance means;
resource receiving means for receiving from the first computer first resource identification information specifying a first resource included in the resources the first user is using;
extraction means for extracting from said advertising database first advertising information included in the advertising information and corresponding to the first resource identification information received by said receiving means; and
broadcast means for broadcasting to the second computer said first advertising information extracted by said extraction means.

3. An advertising device according to claim 2, wherein said advertising database further stores communications addresses for owners of each item of resource identification information included in said resource identification information, said advertising device further comprising:
determination means for determining whether, when said advertising acceptance means has accepted from the computers the unregistered advertising information and a designation for the already registered resource identification information, the owner of the unregistered advertising information is identical with the owner of the already registered resource identification information;
inquiry means for inquiring, pursuant to the results of the determination by said determination means, whether the unregistered advertising information may be correlated with the already registered resource identification information, said inquiry to be made using a communication address for the owner of the already registered resource identification information; and
response receiving means for receiving a response to the inquiry, and in accordance with the response delivering the designation of the already registered resource identification information and the unregistered advertising information to said storing means.

4. An advertising device according to claim 2, wherein:
advertising information contained in said advertising information further includes detailed identification information for specifying detailed information on the network, the detailed information defining advertising content in detail;
said advertising database further records the detailed identification information; and
said advertising acceptance means further accepts the detailed identification information along with a designation for already registered advertising information stored in said advertising database or along with the unregistered advertising information.

5. An advertising device according to claim 4, further comprising notification means, for accepting from the second computer requests for access to detailed information corresponding to the first advertising information, and determining whether or not detailed identification information contained in the first advertising information is stored in said advertising database and if not stored, notifying the second computer to that effect.

6. An advertising device according to claim 4, further comprising:
an access database for storing computer identification information, detailed identification information, and access counts or access frequencies from a computer to the detailed information; and
access database updating means for determining whether or not the first computer has accessed first detailed information specified by first detailed identification information included in the first advertising information and in response to the determination results updating said access database.

7. An advertising device according to claim 6, further comprising:
an incentive database for recording the detailed identification information, incentive information specifying incentives to be awarded to the users, and award conditions for awarding the incentives; and
incentive awarding means for consulting said access database and said incentive database, determining whether or not the first computer has fulfilled any of the award conditions, and if fulfilled, sending to the first computer incentive information correlated with any such fulfilled award condition.

8. An advertising device according to claim 6, further comprising:
an advertising fee database for recording access counts or access frequencies, and advertising fees corresponding to the access counts or access frequencies; and
advertising fee calculation means for
consulting said access database and said advertising fee database,
calculating the access count sum total, or the access frequencies, to the first detailed information, and
reckoning in response to the calculation results advertising fees for the first advertising information.

9. An advertising program for making function a computer for broadcasting advertisements to computers on a network, operated by users, including a first computer operated by a first user and a second computer operated by a second user, the advertising program making the computer function as:
status administration means for administrating the status of the users including the first user and the second user, and for receiving from the first computer and broadcasting to the second computer the status of the first user;
an advertising database for correlatively recording resource identification information specifying resources on the network with advertising information including image data for the advertisements;
advertising acceptance means for accepting from the computers one selected from
unregistered advertising information to be recorded in said advertising database and designations of already registered resource information included in the resource identification information, and
unregistered resource identification information to be recorded in said advertising database;
storing means for storing in said advertising database information accepted by said advertising acceptance means;
resource receiving means for receiving from the first computer first resource identification information specifying a first resource included in the resources the first user is using;
extraction means for extracting from said advertising database first advertising information included in the advertising information and corresponding to the first resource identification information received by said receiving means; and
broadcast means for broadcasting to the second computer said first advertising information extracted by said extraction means.

10. An advertising display method for utilization by user-operated, network-interconnected computers including a first computer operated by a first user and a second computer operated by a second user, the advertising display method including:
a status broadcast step of transmitting, from the first computer to an advertising computer administrating status of users including the first user and the second user, status of the first user for allowing broadcast to the second computer;
a resource detection step of detecting resource identification information specifying a first resource the first user is using, being a resource on the network;
a resource transmission step of transmitting to the advertising computer first resource identification information detected in said resource detection step;
an advertising reception step of receiving from the advertising computer first advertising information relating to the first resource identification information, and including advertising image data; and
an advertising display step of displaying as the first user status the advertising image data included in the first advertising information.

11. An advertising method using a status information administration system wherein a plurality of user terminals is interconnected via a network, information on user status sent from one of the plurality of user terminals is acquired and administrated for each user, look-up requests for status information designating at least one user are received, and administrated user status information correlated with the users is sent to requester user terminals, the advertising method comprising:
a step of detecting information identifying a network resource requested from one of the plurality of user terminals, and correlatively recording the detected information with user information identifying a user using the user terminal;
a step of accepting a status information look-up request designating at least one user from one of a plurality of user terminals, acquiring network resource identification information correlatively recorded with the user designated by the status information request, and acquiring and sending to the look-up requestor user terminal advertising data correlatively stored for each network resource on receiving requests in advance from an advertiser terminal device; and
a step of updating advertising data look-up conditions for each consulting user or for each advertising data item, and, in accordance with the look-up conditions, generating incentive information for a user and reporting it to the user, or calculating an advertising fee for an advertiser and reporting invoice data on the advertising fee to the advertiser's terminal, when it is detected in the requestor user terminal that the advertising data has been consulted.
